(19) United States
(12) Patent Application Publication
(10) Pub. No.: US 2015/0348519 A1
(43) Pub. Date: Dec. 3, 2015

(54) String Alignment Cover

(71) Applicant: Dennis Bishop, Memphis, TN (US)

(72) Inventor: Dennis Bishop, Memphis, TN (US)

(21) Appl. No.: 14/294,549

(22) Filed: Jun. 3, 2014

(51) Int. Cl. G10D 3/14

(52) U.S. Cl. CPC G10D 3/14

(57) ABSTRACT

A string alignment cover to work in conjunction with a string alignment plate.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### FIELD OF THE INVENTION

The invention relates to the decoration and reinforcement of the string alignment plate with the use of a string alignment cover. A string alignment plate is attached to the front side of the head of guitar or other stringed musical instrument just above the nut and has at least one string alignment peg extending from the top of the string alignment plate, where the string alignment peg prevents the string of the musical instrument from bending from the nut of the instrument to the machine head, and instead, the string alignment peg forces the string above the nut to be aligned with the string along the neck of the stringed instrument until the string reaches the string alignment peg. The present disclosure reveals a string alignment cover that goes on top of and covers a string alignment plate, where the string alignment cover comprises a plate and a plurality of hollow tubes extending from the bottom of the plate, where the hollow tubes are the same length as the string alignment peg or pegs that are extending up from the string alignment plate, where the hollow tubes are located so that fastening means can go through the plate of the string alignment cover, through the hollow tubes, through the plate of the string alignment plate and attach the string alignment cover and string alignment plate to the head of the stringed musical instrument.

In a second embodiment of the string alignment cover, the string alignment cover has a plurality of reinforcement means extending from the bottom of the string alignment cover plate, such that the reinforcement means are located on the bottom of the string alignment cover plate so that the reinforcement means would go into the top of the plurality of string alignment pegs extending up from the string alignment plate, where when the plurality of reinforcement means of the string alignment cover are inserted into the plurality of string alignment pegs of the string alignment plate, and both the string alignment cover and string alignment plate are attached to the head of a musical instrument, the reinforcement means prevent the string alignment pegs from being misaligned relative to the nut of the stringed musical instrument.

### BACKGROUND OF THE INVENTION

The string alignment plate was developed to minimize the friction created at the nut as that portion of the string above the nut bends at the nut of a stringed musical instrument in order to reach the tuning peg or machine head and that portion of the string above the nut bends away from remaining in-line or parallel with the same string as it extends from the bridge to the nut along the neck of the instrument. The string alignment cover works with the string alignment plate in a decorative capacity and reinforcement capacity which are attached to the front side of the head of guitar or other stringed musical instrument just above the nut. As a decorative capacity, the string alignment cover allows the designer of the string alignment cover to place a design or logo on top of the string alignment cover in the same fashion a truss rod cover would. As a means of reinforcement, the string alignment cover anchors the top of the string alignment pegs to the bottom of the string alignment cover with the use of a plurality of reinforcement means that are positioned to insert into the top of the string alignment pegs.

In U.S. Pat. No. 7,863,508, Bishop discloses a string alignment plate. The present disclosure works in conjunction with the previously revealed string alignment plate.

### SUMMARY OF THE INVENTION

The string alignment cover works in conjunction with a string alignment peg on front side of the head of guitar or other stringed musical instrument just above the nut for decorative purposes and to assure that the string above the nut of the stringed musical instrument remains in-line or parallel with the same string as it extends from the bridge to the nut along the neck of the instrument. The string alignment cover first reinforces the string alignment pegs of the string alignment plate by being a cap on the top of the string alignment plate. That is, because the plurality of hollow tubes of the string alignment cover are the same length as the plurality of string alignment pegs of the string alignment plate, the string alignment pegs are constrained from moving because in order to move, the string alignment pegs would need to not only bend but also deform the plate of the string alignment cover.

A second means of reinforcement of the string alignment pegs occurs if the string alignment cover has a plurality of reinforcement means attached to the bottom of the plate of the string alignment cover. In this instance, the plurality of reinforcement means are positioned so as to insert into the top of the plurality of string alignment pegs on the string alignment plate, and the reinforcement means then act as an anchor at the top of the string alignment pegs, preventing the string alignment pegs from becoming misaligned.

### BRIEF DESCRIPTION OF THE SEVERAL VIEWS OF THE DRAWING

FIG. 1 is a view of a string alignment cover positioned over a string alignment plate showing the positioning of the hollow tubes and a string alignment peg; and

FIG. 2 is a view of the bottom of the plate of the string alignment plate showing the location of the plurality of hollow tubes and the plurality of reinforcement means; and

FIG. 3 is a view of a guitar displaying the head, nut, machine heads, strings, and the location of the extended truss rod cover, which is directly over the string alignment plate.

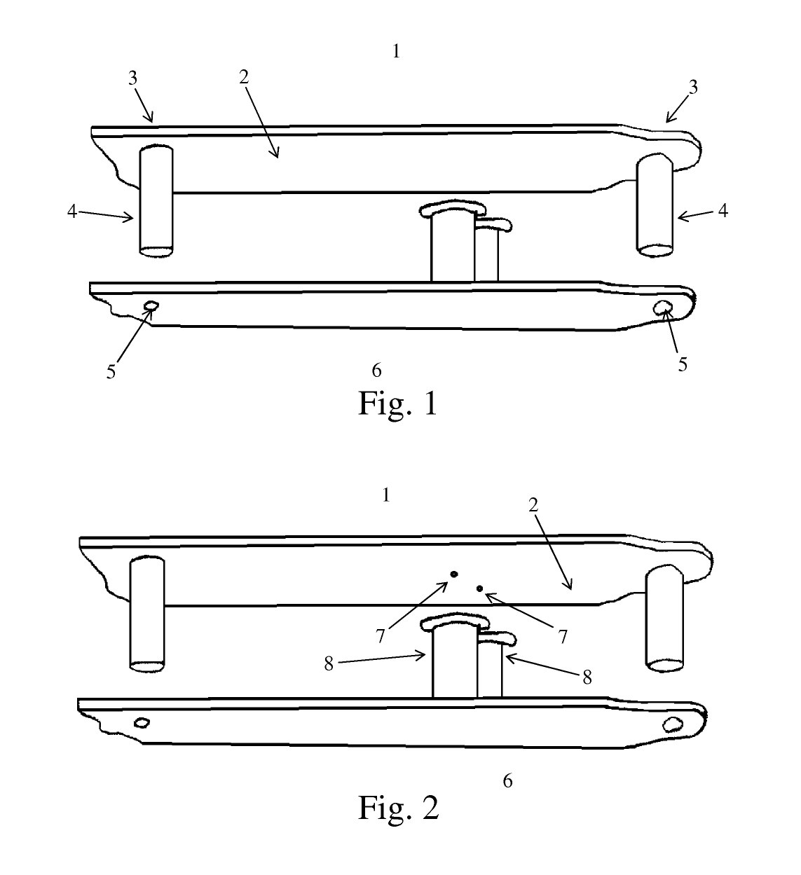

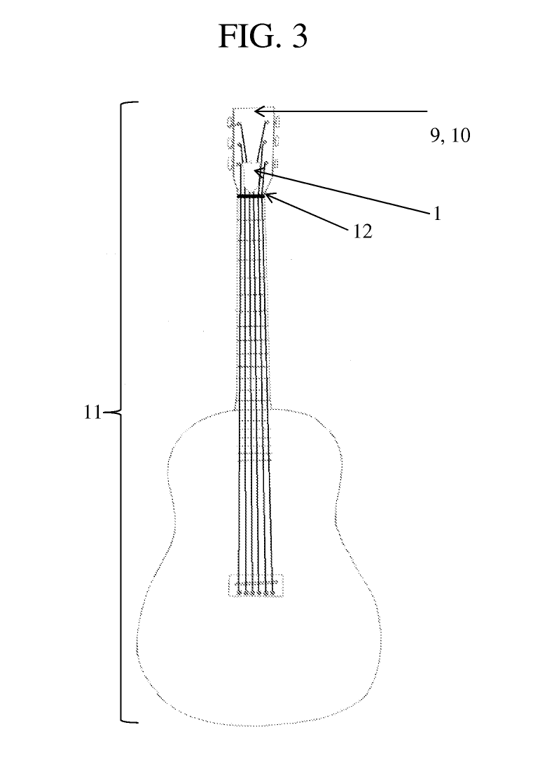

### DETAILED DESCRIPTION OF THE INVENTION

A string alignment cover 1 comprising a plate 2, a plurality of holes 3 positioned so that the string alignment cover 1 can be attached to the front side 9 of the head 10 of a guitar or other stringed musical instrument 11 just above the nut 12, and a plurality of hollow tubes 4 attached to the bottom of the plate 2, where the hollow tubes 4 are aligned with the plurality of holes 3, so that fastening means can pass through the plurality of holes 3 in the plate 2, through the plurality of tubes 4, through the holes 5 located in a string alignment plate 6, and attach the string alignment cover 1 and string alignment plate 6 to the head of a stringed musical instrument 11.

In a second embodiment of the string alignment cover 1, on the bottom of the plate 2 of the string alignment cover 1 are a plurality of reinforcement means 7, such that the plurality of reinforcement means 7 are located so that when the string alignment cover 1 is positioned over a string alignment plate 6 the plurality of reinforcement means 7 are inserted into the top of the string alignment pegs 8.

What is claimed:

1. A string alignment cover designed to work in conjunction with a string alignment plate that has a plurality of string alignment pegs and which are attached to the front side of the head of guitar or other stringed musical instrument just above the nut comprising:
a. a plate;
b. a plurality of holes in the plate located so that the holes can have a plurality of fastening means pass through them to attach the string alignment cover to a stringed musical instrument;
c. a plurality of hollow tubes located on the bottom of the plate, aligned with the plurality of holes such that a plurality of fastening means pass through the plurality of holes in the plate, though the plurality of hollow tubes, through the plurality of holes in the plate of a string alignment plate, and allow the string alignment cover and string alignment plate to be attached to the head of a stringed musical instrument; and
d. where the hollow tubes are the same length as the string alignment pegs of the string alignment plate.

2. The string alignment cover of claim 1 where there are a plurality of reinforcement means attached to the bottom of the plate, located such that when the string alignment cover is positioned over the string alignment plate, the plurality of reinforcement means are inserted into the top of the plurality of string alignment pegs of the string alignment plate.
